(19) United States
(12) Patent Application Publication
(10) Pub. No.: US 2024/0391267 A1
(43) Pub. Date: Nov. 28, 2024

(54) PRINTING WITH PROGRAMMABLE INK FOR RAPID PACKAGING ITERATIONS

(71) Applicant: Accenture Global Solutions Limited, Dublin (IE)

(72) Inventors: Noah Gideon Pacik-Nelson, Boston, MA (US); Aditi Maheshwari, Boston, MA (US)

(21) Appl. No.: 18/321,955

(22) Filed: May 23, 2023

(51) Int. Cl. B41J 29/393; B41J 2/32; B41J 2/47

(52) U.S. Cl. CPC B41M 7/0081; B41F 3/46; B41F 13/08; B41F 13/193; B41F 16/002; B41M 1/18

(57) ABSTRACT

An automated system and method of printing designs. The system and method can manage print content by application of programmable inks to selected areas in the packaging where frequently modified designs are printed. Such an approach allows the area to be precisely activated to correspond to the target pattern of the desired design and permanently change color. In some embodiments, any change in the text on the packaging/label would then only need to be translated into a corresponding UV or heat pattern, thereby avoiding the production of a new print cylinder to print the changed design. The proposed embodiments are effective in reducing downtime during print operations as well as expanding the capacity of the print apparatus to dynamically respond to changes in print designs.

### TECHNICAL FIELD

The present disclosure generally relates to a method and system for industrial printing. More specifically, the present disclosure relates to a system and method for dynamic printing of package labels using color changing inks.

### BACKGROUND

Containers for products, such as liquid, food, sanitary articles, and other commercial products are typically provided with an imprint for identifying the product and/or for high-quality product presentation. The imprint can generally be applied either directly to a print area on an outer wall of a container (direct print) or to a label as an additional print. The print color or printing ink is applied by means of one or a plurality of print heads, directly to an outer surface of the container or the label. The printed print image can include a series of printed objects such as characters, logos, patterns and color gradients. The print image may be single-colored or multi-colored. In the case of multi-colored print images, separate print heads are often provided for the individual print colors, such that each print head applies the respective print color to the print area.

One type of printing process commonly used for printing, particularly on curved surfaces such as a cylinder (also referred to as a roller or drum), is a rotary printing press. A rotary printing press is a printing press in which the images to be printed are curved around a cylinder. Printing can be done on various substrates, including paper, cardboard, and plastic. Substrates can be sheet feed or unwound on a continuous roll through the press to be printed and further modified if required (e.g., die cut, overprint varnished, embossed, etc.). Rotary printing involves using a rotary screen, or a screen that is in a cylindrical form. A separate screen is required for each color of the design being printed. More complex designs require the application of many different colors, and typical rotary screen printing machines have the capacity for up to 20 screens.

While rotary printing remains popular, it is nevertheless associated with a significant disadvantage-when orders are small and the design must be changed frequently, the process is no longer economical or efficient. This is due to changes in design necessitating the production (cut) of a new roller/cylinder and other equipment, which represent a considerable additional cost. In addition, the setup for each round of rotary printing often takes weeks and can cost tens of thousands of dollars, so print jobs that run millions of units without changes to graphics or text copy are highly preferred over smaller, more dynamic jobs.

There is a need in the art for a system and method that addresses the shortcomings discussed above.

### SUMMARY

As described herein, the proposed systems and method apply irreversible color changing inks, also referred to herein as “programmable inks” that are combined with heat, ultraviolet (UV), and other (“trigger mechanisms”) in regions of the packaging that are prone to frequent changes. These specialized inks allow for the introduction of label changes without undesirable and lengthy halts in production. The proposed systems and methods describe techniques to incorporate the application of such inks to selected areas in the packaging where frequently modified designs are printed. Such an approach allows the area to be precisely activated to correspond to the target pattern of the desired text and permanently change color. In some embodiments, any change in the text on the packaging/label would then only need to be translated into a corresponding UV/heat pattern, thereby avoiding the production of a new roller/cylinder to print the changed design. Because the rollers are expensive, avoiding the production of new rollers is a significant cost savings. Additionally, the proposed embodiments are effective in reducing downtime during print operations as well as expanding the capacity of the print apparatus to dynamically respond to changes in print designs.

In one aspect, the disclosure provides a computer-implemented method of printing designs. The method may include receiving, at a design application accessed at a computing device associated with a rotary printing process, a first design image. The method may include printing programmable ink onto a first programmable region of a substrate, the first programmable region initially including a first appearance. The method may include projecting one or both of light and heat to the first programmable region to cause the programmable ink on the first programmable region to transform from the first appearance to a second appearance corresponding to the first design image. The method may include receiving, at the design application, a second design image. The method may include printing programmable ink onto a second programmable region of the substrate, the second programmable region initially including a third appearance. The method may include projecting one or both of light and heat to the second programmable region to cause the programmable ink on the second programmable region to transform from the third appearance to a fourth appearance corresponding to the second design image.

In another aspect, the disclosure provides a method for printing designs. The method may include receiving, at a design application accessed at a computing device associated with a rotary printing process, a first design image. The method may include printing programmable ink onto a first programmable region of a first substrate, the first programmable region initially including a first appearance. The method may include projecting one or both of light and heat to the first programmable region to cause the programmable ink on the first programmable region to transform from the first appearance to a second appearance corresponding to the first design image. The method may include receiving, at the design application, a second design image. The method may include printing programmable ink onto a second programmable region of a second substrate, the second programmable region initially including a third appearance. The method may include projecting one or both of light and heat to the second programmable region to cause the programmable ink on the second programmable region to transform from the third appearance to a fourth appearance corresponding to the second design image.

In yet another aspect, the disclosure provides a system for printing designs that includes an ink reservoir; a first cylindrical drum of a printing apparatus in fluid communication with the ink reservoir; a conveyor for conveying a substrate adjacent to the paint roller; a projector positioned adjacent to the conveyor such that the projector can project one or both of heat and light onto the substrate; a device processor in electrical communication with at least the projector; and a non-transitory computer-readable medium (CRM). The CRM stores software comprising instructions executable by the device processor which, upon such execution, cause the device processor to: (1) receive, at the device processor, a first design image; (2) automatically control the first cylindrical drum to print programmable ink onto a first programmable region of a first substrate, the first programmable region initially including a first appearance; (3) automatically control the projector to project one or both of light and heat to the first programmable region to cause the programmable ink on the first programmable region to transform from the first appearance to a second appearance corresponding to the first design image; (4) receive, at the device processor, a second design image; (5) automatically control the first cylindrical drum to print programmable ink onto a second programmable region of a second substrate, the second programmable region initially including a third appearance; and (6) automatically control the projector to project one or both of light and heat to the second programmable region to cause the programmable ink on the second programmable region to transform from the third appearance to a fourth appearance corresponding to the second design image.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

While various embodiments are described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted.

This disclosure includes and contemplates combinations with features and elements known to the average artisan in the art. The embodiments, features, and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic diagram of a dynamic print augmentation system, according to an embodiment;

FIG. 2 is a schematic flow diagram of a process for modifying a print design during an industrial printing cycle, according to an embodiment;

FIG. 3 is a diagram of an embodiment of an ink programming process, according to an embodiment;

FIGS. 4-6 are a sequence of drawings showing an example of a printing cycle generated by a printing apparatus incorporating the proposed systems, according to an embodiment;

FIG. 7 is a flow chart depicting a method of managing print content during data migration, according to an embodiment; and

FIG. 8 is a diagram depicting example environments and components by which systems and/or methods, described herein, may be implemented.

### DESCRIPTION OF EMBODIMENTS

Described herein are systems, methods, devices, and other techniques for industrial printing that accommodates rapid printing iterations. The techniques described herein provide an efficient and cost-effective alternative to facilitate dynamic print operations in programmable packaging. Rather than require industries to make burdensome supply chain modifications, the proposed embodiments enable the production of new designs ‘on-the-fly’. The proposed systems and methods are designed to integrate seamlessly with existing rotary printing presses such as offset, rotogravure, and flexo (flexography) printing lines. As described herein, the proposed systems and method apply irreversible color changing inks, also referred to herein as “programmable inks” that are combined with heat, ultraviolet (UV), and/or temperature projectors (“trigger mechanisms”) in regions of the packaging that are prone to frequent changes. These specialized inks allow for the introduction of label changes without undesirable and lengthy halts in production. Indeed, in contrast to what has traditionally been a stop in printing extending from days to weeks, the embodiments enable the turnaround time for the transition to the new labels to last only a few minutes.

The proposed embodiments contemplate the usage of irreversible thermochromic (color change triggered by temperature change) and photochromic (color change triggered by UV light exposure) inks in programmable packaging by applying these inks to selected areas in the packaging where frequently modified text/symbols (ingredients, nutritional info, certifications, regulatory info, etc.) are printed. Such an approach allows the area to be precisely activated to correspond to the target pattern of the desired text and permanently change color. One benefit of using these inks is that the pattern that is shone on these inks can be changed rapidly, per the dynamic needs of the brand or manufacturer. In some embodiments, any change in the text on the packaging/label would only have to be translated into a corresponding UV/heat pattern, thereby avoiding the production of a new roller/cylinder to print the changed text.

As noted earlier, industrial packaging productions commonly use rotary printing, where a series of metal rollers apply a sequence of colored inks to a substrate. The design that these rollers apply is cut into the surface of the metal, requiring new rollers to be cut whenever a change needs to be made. Additionally, once the new rollers are made, the production line can be paused while the new rollers are installed. This approach slows the packaging change process, making it a highly inefficient endeavor. In some cases, the preparation and installation of new rollers can pause printing and, consequently, production for weeks to months.

In order to address these and other challenges, the proposed systems and methods offer an option by which changes in design can be seamlessly integrated into the ongoing print cycle without the need for prolonged disruption to the operation of the printing apparatuses. For purposes of introduction, a schematic diagram of one embodiment of a dynamic print augmentation system (“system”) 100 is presented. In different embodiments, the system 100 is ready for incorporation into existing printing architectures, such as a printing apparatus 160. The system 100 brings a flexibility and freedom to design selection to even the most hardware-heavy printing equipment, as it shifts the burden for implementing the desired changes from the print components such as the drums or screens to a software step involving relatively small and portable components that can be readily accommodated by the apparatus.

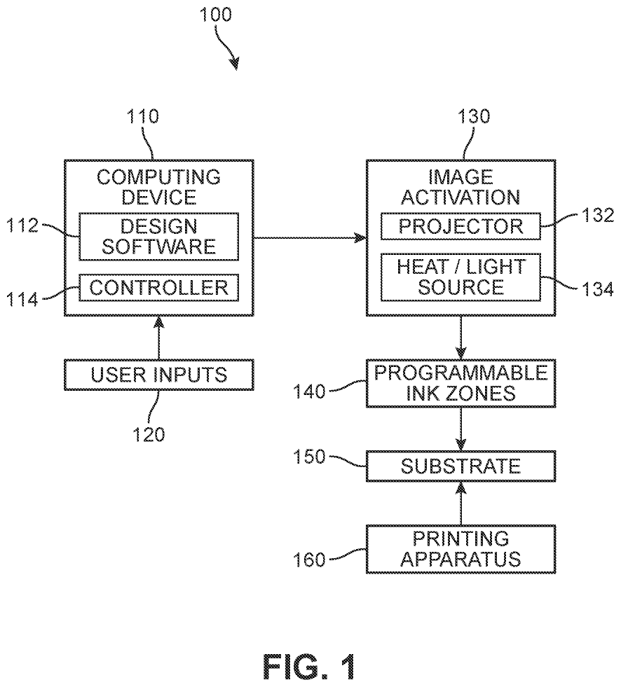

As shown in FIG. 1, in different embodiments, the system 100 can include a computing device 110 (having a device processor) on which a design software 112 can be executed or accessed (e.g., over a network), and from which information and control signals transmitted to connected components. In different embodiments, a network could include one or more Wide Area Networks (WANs), Wi-Fi networks, Bluetooth or other Personal Area Networks, cellular networks, as well as other kinds of networks. It may be appreciated that different devices could communicate using different networks and/or communication protocols. The devices can include computing or smart devices as well as more simple loT devices configured with a communications module/interface and a sensor. The communication module may include a wireless connection using Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. In many cases, the communication module is a wireless connection; however, wired connections may also be used. For example, the communication module may include a wired serial bus such as a universal serial bus or a parallel bus, among other connections. In addition, each device can include provisions for communicating with, and processing information from, components of system 100. Each device may include one or more processors and memory. Memory may comprise a non-transitory computer readable medium. Instructions stored within memory may be executed by the one or more processors.

In different embodiments, a user can submit various user inputs 120 via the computing device 110, for example through a user interface, to make changes to the print design at design software 112, and/or to initiate the dynamic print augmentation via a controller module 114. In some embodiments, two different custom software programs will be provided (a) to upload the design and then (b) to control the projector output. The proposed embodiments can then pair well with or otherwise be incorporated readily into other technologies that, while commonplace in software development, may have yet to make their way into the packaging production space. For example, a nonlimiting example may include version control software, where tracking, managing and approving packaging design changes can automatically be propagated into production and easily be reversed if necessary via software changes.

In different embodiments, the software application can offer content via native controls presented via an interface. Throughout this application, an “interface” may be understood to refer to a mechanism for communicating content through a client application to an application user. In some examples, interfaces may include pop-up windows that may be presented to a user via native application user interfaces (UIs), controls, actuatable interfaces, interactive buttons or other objects that may be shown to a user through native application UIs, as well as mechanisms that are native to a particular application for presenting associated content with those native controls. In addition, the terms “actuation” or “actuation event” refers to an event (or specific sequence of events) associated with a particular input or use of an application via an interface, which can trigger a change in the display of the application. This can include selections or other user interactions with the application, such as a selection of an option offered via a native control, or a ‘click’, toggle, voice command, or other input actions (such as a mouse left-button or right-button click, a touchscreen tap, a selection of data, or other input types). Furthermore, a “native control” refers to a mechanism for communicating content through a client application to an application user. For example, native controls may include actuatable or selectable options or “buttons” that may be presented to a user via native application UIs, touch-screen access points, menus items, or other objects that may be shown to a user through native application UIs, segments of a larger interface, as well as mechanisms that are native to a particular application for presenting associated content with those native controls.

In different embodiments, the controller module 114 (also referred to herein as a controller unit, or simply controller) can receive user inputs 120 and initiate a dynamic print augmentation. In some embodiments, the controller module 114 can for example transmit control signals to an image activation component 130, which can comprise an image projector 132 that emits the necessary activation signal via a heat/light source (“activator”) 134. Once the projector 132 has received its instructions from the computing device 110, it can adjust its output to ensure the heat/light source 134 targets only the parts of the programmable ink that are to be activated. For example, some portions of substrate 150 traveling through the printing apparatus 160 can include programmable ink zones 140 which are the only areas where the activator can cause an effect or change in appearance. For example, in the case of thermochromic or photochromic inks, the image can be transmitted as a set of activation signals that, when received by or applied to the programmable ink zones 140, cause the programmable ink zones 140 to undergo highly specific changes in appearance that correspond to the new design.

In different embodiments, both (or either) UV and heat can be used to precisely program color changing inks in the designated target are. Some non-limiting example techniques of projecting an image using UV or heat include DLP (Direct Light Processing) and laser rastering. DLP uses a micromirror array to selectively reflect light from a light source onto a surface. This technique is commonly used in resin 3D printing. Laser Rastering, on the other hand, uses a static laser emitter and mirrors to direct a beam in a controlled manner onto a surface. Another method uses a dual-galvanometer system that rotates mirrors using high speed motors.

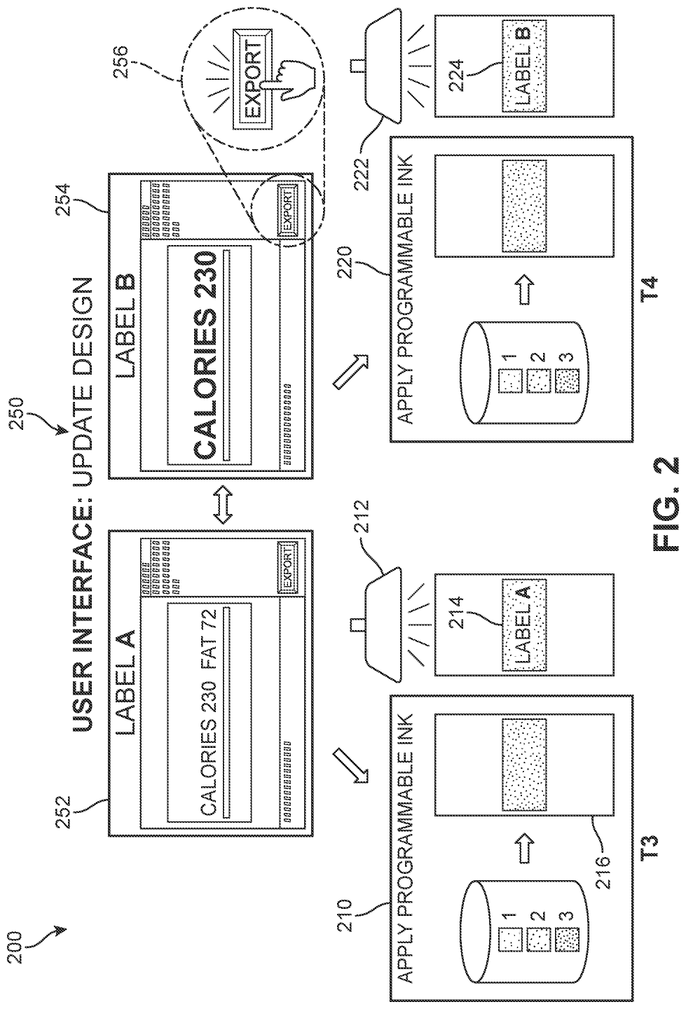

To provide the reader with further understanding of the embodiments, an example of a design-switchover process 200 is depicted in FIG. 2. In this case, the manufacturer may have initially been tasked with including a first pattern 214 in their packaging material 216 that adhered to a first set of guidelines where a nutrition facts listing described the calories and fat content of a food item in a first font size and on the same line. During this time (third time T3), the printing apparatus had incorporated the system 100 of FIG. 1. Thus, a first pattern 214 (“Label A”) was obtained and inputted via a first user interface 252 into the design software and prepared for transfer via a first activation source 212 and a control signal with the design sent to the projector. The printing apparatus has coated a first region of packaging material 216 with a first application 210 of programmable ink (e.g., a first programmable region). When this region is positioned beneath the first activation source 212, the “Label A” first design 214 is produced as a permanent change in the appearance of the substrate.

However, at a subsequent fourth time T4, the manufacturer is requested to update the label to adhere to a newly passed second set of guidelines that require the calories to be shown in a larger font size than before, and in isolation. The manufacturer obtains a second design 224 (“Label B”) and inputs this image data into the design software via a second user interface 254 (which may be the same as first user interface 252) and prepares the new information for transfer, initiating the process for example by a selection of a first control option 256. In response, a second activation source 222 (which may be the same as first activation source 212) projects the new design image onto the packaging material 216 which has had a second application 220 of programmable ink printed onto a second zone (e.g., a second programmable region). When the second zone is positioned beneath the second activation source 222, the “Label B” second design 224 is produced as a permanent change in the appearance of the substrate.

It can be appreciated that the proposed embodiments enable modifications to the printing output to occur without major disruption to the operational flow of the printing apparatus and with no changes in hardware. As noted earlier, this technique relies on the application of a programmable ink onto a pre-designated zone of the substrate that is identified as the target area for the activation source. In one example, the programmable ink can be applied using a roller in the printing press similar to the way non-programmable ink is applied in other processes. The activation source has no effect on the areas of the substrate where normal (i.e., non-programmable) ink has been applied.

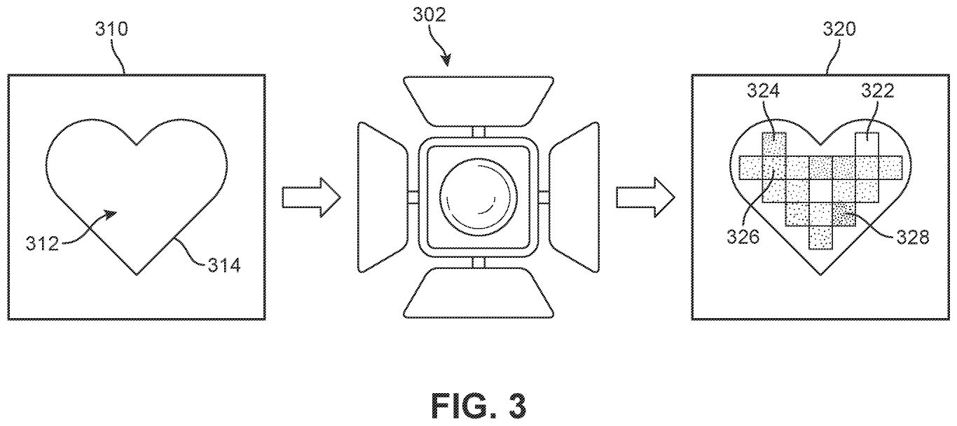

Referring to FIG. 3, in some embodiments, an activation source 302 can include a UV-light source, whose output can be carefully modulated by the control unit to produce only the amount/degree of UV light desired in only the target pixel areas in the zone of programmable ink. In one embodiment, in a first stage 310, a programmable region 314 can be created on a substrate 316 that includes programmable ink 312. In a second stage 320, activation source 302 such as UV light can be projected through an LCD (liquid crystal display) or a digital micromirror device that include an array of individually addressable or controllable micromirrors that can be used to spatially modulate the (e.g., invisible) light or heat output in a highly nuanced and customizable manner. In some embodiments, the “image” is projected onto the programmable region (which may initially simply appear blank or all one color, e.g., white or the same color as the surrounding area) of the substrate 316. In response, target pixels or otherwise smaller units or sub-regions 324 of the programmable region are activated and undergo an irreversible change in appearance (color), saturation, or lightness (e.g., HSL (hue, saturation, lightness) and HSV (hue, saturation, value) color models), based on the selected software design. For purposes of this example, a first sub-region 326 has taken on a first color (e.g., aqua), and a second sub-region 328 has taken on a second color (e.g., lavender). Furthermore, it can be appreciated that a third sub-region 322 has remained blank or white, due to the selective manner in which the activation source impacted the programmable region—in this case, the projected light did not target the third sub-region 322, leaving that portion unexposed, and therefore unchanged from its earlier appearance. For example, in some embodiments, the activation source is passed through a digital mask which selectively targets only those portions of the programmable region that correspond to the controlling image design. In some embodiments, the digital mask may include, for example, an LCD in which the backlight of the LCD provides the light and the portions of the LCD that are not lit do not project light. Thus, light is only projected in the pattern produced by shining light from the backlight of the LCD. While LCD masks can incorporate specifically programmable occlusion using polarization, in other examples, the same kind of effect can be realized by not shining a source (e.g., lasers, DMD devices, LED displays, etc.) at that area in the first place.

For purposes of this application, in different embodiments, the programmable inks can include one or more of a thermochromic ink, a photochromic ink, a thermochromic ink, a fluorescent ink, a UV ink, a black light ink, an infrared ink, a phosphorescent ink, a thermo-tactile ink, and a leuco dye. In some cases, the different types of ink can be characterized by the associated activation trigger. For the thermochromic pigments, the color changes according to different temperatures, and the color changing form includes changing from colorful to colorless (that is, from one color to non-color), changing from colorless to colorful, and changing from colorful to colored (that is, from one color to another color). With respect to photochromic pigments, different changes of color can be realized through conversion of reception and loss of UV light, and the main change process includes changing from colorless to colorful, changing from colorful to colorless, and changing from colorful to colorful, or change of different colors is realized according to different wavelength of the UV light. In some embodiments, a pressure-sensitive pigment can be used where color changing is realized by receiving different pressures. It should be understood that the different types of color changing inks (e.g., the thermochromic pigment and the photochromic pigment) can be mixed, so that change of different colors can be realized according to the change of the temperature and the UV light. The pressure-sensitive pigment can also be mixed with the thermochromic microcapsule pigment or the photochromic microcapsule pigment, so as to realize more forms of changes.

In some embodiments, different colors can be realized by layering thermochromic inks as well. For example, two thermochromic paints-“Black to Pink” at temperature A and “Blue to Colorless” at a lower temperature B may be selected. In one scenario, the first layer “Black to Pink” can be initially applied. After this layer completely dries, the system can paint the second layer using the “Blue to Colorless” paint. Afterwards, when the system begins heating the painted object, the color can first turn from blue to black and then the black can turn to pink. This can be done with three or more thermochromic paints/inks with the appropriately chosen colors and activation temperatures.

Some further details regarding color-changing inks can be found at the website post by SpotSee, “What are Irreversible Inks or Permanent Color Change Temperature Pigments?”, retrieved from https://spotsee.io/technologies/irreversible-inks and at the website by Matsui International Company, Inc., “Color Changing Materials-Photochromatic”, retrieved from https://www.matsui-color.com/ourproducts/specialty-products/photolock, both of which are herein incorporated by reference in their entirety.

In different embodiments, various types of trigger mechanisms can be used to effect the color change as desired. In some embodiments, there can be multiple layers of color patterns, with each layer reactive to a different temperature or wavelength of light. Thus, the layers can be arranged such that the layers closer to the surface not only absorb their specific wavelength but also do not occlude other wavelengths from penetrating to the layers beneath them. Depending on the label appearance that is desired, the trigger mechanism may be selected to cause only the appropriate design to appear (or change color). As noted above, in different embodiments, the programmable inks can be thermochromic (color change triggered by temperature change) or photochromic (color change triggered by UV or other designated wavelength of light exposure), and so the activation source can be selected based on the programmable ink that is to be used. In some embodiments, the final application can be selected by shining precise high temperature beams, heat, or UV light, onto the programmable region, which would trigger a permanent color change in the areas where the beam hits the surface. Laser rastering, UV projectors, or other technology can allow for precise shining of UV light or varying temperature on the inks. This process allows small changes in the designs to be rapidly propagated through to the production line without the requirement for new rollers to be cut or installed.

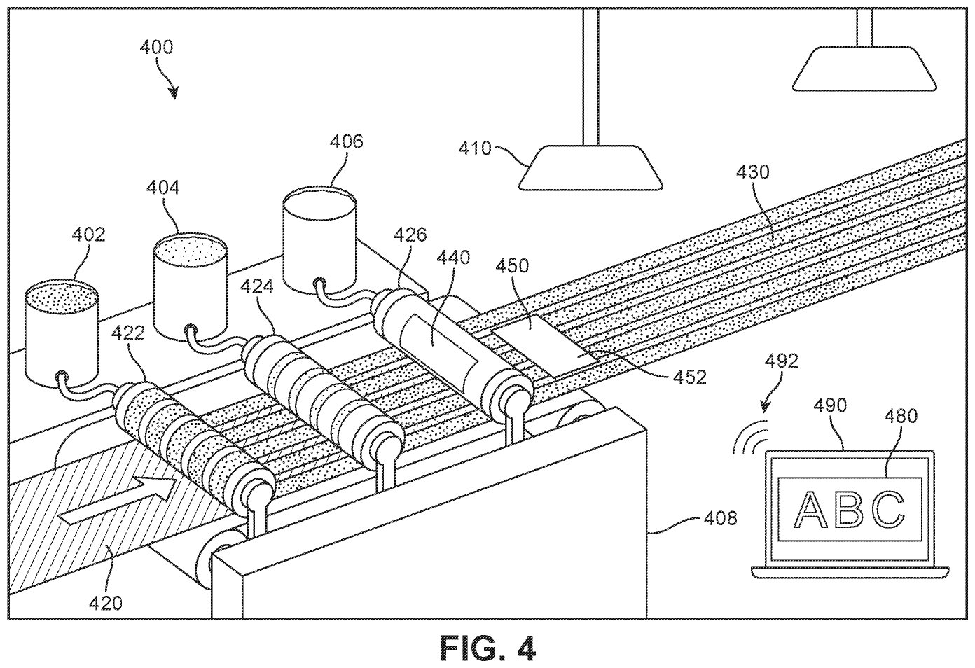

For purposes of illustration, a sequence of drawings in FIGS. 4, 5, and 6 show a simplified example of the dynamic print augmentation system in operation. While the embodiment shown in FIGS. 4-6 shows applying the first programmable region and the second programmable region to a single substrate, it is understood that other embodiments may include applying the first programmable region to a first substrate and applying the second programmable region to a second substrate. For example, such an embodiment may include a situation where the design is changed after applying the first programmable region to the first substrate and the new design is printed on the second programmable region. In FIG. 4, a first ink reservoir 402, a second ink reservoir 404, and a third ink reservoir 406 are depicted; for this example, each reservoir has a different color or type of ink. More specifically, the first ink reservoir 402 supplies a first visible color (e.g., red), and the second ink reservoir 404 supplies a second visible color (e.g., yellow). In addition, the third ink reservoir 406 supplies a programmable ink, which may have an invisible or visible color with respect to human eyesight. A substrate 420, such as cardboard, is moving through printing apparatus 400 and passing beneath a series of rollers. A first roller 422 is connected to the first ink reservoir 402, a second roller 424 is connected to the second ink reservoir 404, and a third roller 426 is connected to the third ink reservoir 406. As the substrate passes under and against the first roller 422, a first pattern is generated based on the cuts on the exterior surface of the first roller 422 and the ink color from the first ink reservoir 402. As the substrate next passes under and against the second roller 424, a second pattern is generated that is a combination of the cuts on the exterior surface of the second roller 424 and the ink color from the second ink reservoir 404 with the previously applied first pattern. In addition, as the substrate then passes under and against the third roller 426, a third pattern is generated that is a combination of the cuts on the exterior surface of the third roller 426 and the ink color from the third ink reservoir 406 with the previously applied second pattern.

More specifically, the third roller 426 includes a first cut arrangement 440 that permits the application of programmable ink (from third ink reservoir 406) onto substrate 420. An example of this output is represented as a first programmable region 450, which has not yet been exposed to an activation source and so is currently in an initial blank/unexposed or default state 452. In general, like existing rotary printing, these programmable regions can be pre-defined. As a printed substrate 430 with this pattern is produced, it travels away from the roller area. In some embodiments, the printed substrate 430 may then begin an approach toward the area in which the activation source can be registered, shown here as a first projector 410. In other words, once the ink is deposited onto the pre-defined region, the programmable print area goes through an additional programming step, where temperature, UV, or another information carrier, can be applied to ensure certain parts of the region undergo a permanent state change. Around or before this time, a computing device 490 (or computer 490) may transmit a first selected design 480 to the first projector 410 over a network 492.

As a general matter, tooling for deposition of the programmable ink is deployment dependent. For example, programmable inks could be deployed in a variety of applications including but not limited to: (a) Roll-to-roll printing using rollers and ink reservoirs; (b) Packaging; (c) Textiles; (d) Industrial painting using compressed air and spray nozzles; and (e) Automotive Paneling, etc. In addition, it can be appreciated that different applications can require different pigment properties including ink viscosity, grinding fineness, solids content amount/percentage, and substrate compatibility with the prospective ink. Thus, in different embodiments, inks can be first matched to the deposition technique before other properties like photochromism or thermochromism are considered. An industrial deployment can use existing paints or pigments as a base on which properties like photochromism or thermochromism can be introduced. If introducing the programmability substantially changes the composition or properties, the plant can first perform some tests (e.g., iteration and experimentation) to find the optimal approach for the deposition technique and type of ink.

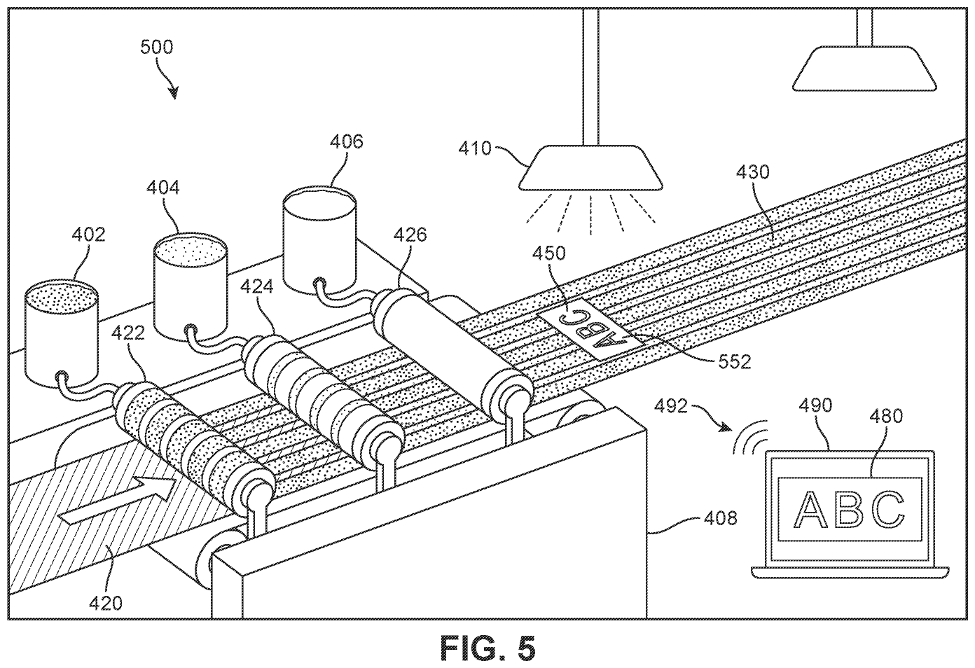

Moving to FIG. 5, the first programmable region 450 of the printed substrate 430 has arrived under the first projector 410. In some embodiments, the first projector 410 can shift from an ‘OFF’ state to an ‘ON’ state once the first programmable region 450 is at the pre-designated position that is correctly aligned with the light/heat projector output. In other words, it is recommended that the programmable region be positioned within the correct target projection area before the projector emits the image. In this case, the correct alignment refers to the relative position of first programmable region 450 underneath the light/heat such that the projected image can be targeted within the first programmable region 450 in the desired orientation and arrangement. The first projector 410 switches on and exposes the first programmable region 450 to the activation source. In some embodiments, the period of time needed for the first programmable region 450 to irreversibly transform can range from milliseconds to several seconds. Thus, in different embodiments, at this junction the printing apparatus 400 may briefly pause its forward conveyance of the substrate to ensure the first programmable region 450 is exposed to the activation source for a sufficient duration and trigger a color transformation into a first dynamic output 552 (e.g., “ABC”) corresponding to the first selected design 480, although in other embodiments, no pause is required.

In different embodiments, based on the constraints for deposition, a manufacturer might be limited to a selection of only thermochromic or photochromic inks for the programming operation. As noted earlier, photochromics are programmable with light, where the wavelength of light that activates the photochromic is variable and selected based on the application. It should be understood that because protection and readability of packaging is required, photochromics for visual use, such as labeling, is recommended to be chosen to have an activation wavelength outside of the visual spectrum (otherwise the protection would block out all visibility under ambient conditions). Although there are cases where programmable photochromics could have activation wavelengths in the visual spectra, this is limited to applications performed outside of ambient conditions, where exposure to visible frequencies of light would not occur, and humans are no longer required to read the patterns. Such cases would likely be limited to closely controlled machine vision applications.

In different embodiments, light can be programmatically displayed using mechanisms involving reflection, masking, rastering, and other methodologies. Parameters for selecting a particular approach can include, for example, the following: (a) Mechanical complexity and reliability; (b) Activation time and energy required to color the ink; (c) Maximum thermal load on the substrate; (d) Maximum thermal load of auxiliary components; (e) Throughput required of production line; (f) Space constraints if required to fit among existing components; and (g) Cost constraints, among others.

More specifically, rastering and/or engraving as a mechanism for programming light is based on the motion of a high intensity light source in a back-and-forth pattern or along a specified set of curves. The intensity can be modulated to achieve varying intensities (e.g., Digital Modulation (such as PWM, or pulse width modulation) and/or Analog Modulation (i.e., varying power to laser). Common light sources for rastering and engraving include lasers (e.g., diodes, fiber, CO₂, etc.) and lens-focused sources of uncollimated light (e.g., LEDs, electric arcs, etc.). In addition, movement mechanisms for rastering and/or engraving can include Single-Axis or Dual-Axis Gantries (Cartesian, Core XY, Delta, etc.) incorporating motors that move belts or arms that change the position of the mirrors, light source, or lens in specific patterns. In some embodiments, a Galvonometer Laser Scanner is used for motion, based on static motors rotate mirrors to direct lasers or other focused light sources, or a Polygon Laser Scanner which uses geometrical mirrors that rotate for high-speed laser positioning. Other mechanisms for programming light include masking (LCDs, etc.) and reflection (DMDs, etc.).

For purposes of illustration, an example of some parameters that may be considered during the programming process selection are now described. In this example, a photochromic ink (such as Photolock Aqualite) meeting the deposition criteria of a rotogravure process and material compatibility criteria of a cotton substrate can be effectively tuned for consistent printing at maximum production speeds. In order to identify a suitable light programming technology, the parameters described previously can be examined with the design constraints of the product. Based on a sample datasheet such constraints could include: (a) a minimum Delta-E of 30 is selected to ensure high-contrast and easily visible patterning; (b) 15 W×2 black light bulbs (peak 352 nm) at 3 cm results in a surface power density of 3 mw/cm²⁺; and (c) 15 min of exposure hits the target Delta-E of 30 with a total energy of 2.70 J/cm². A target feed rate of 50 meters per minute can then be selected to ensure profitability. In this example, to meet both the Delta-E requirements and the feed rate requirements, the power of the light source is recommended to be increased to target similar total J/cm² values in shorter periods of time: 50 m/min=83 cm/sec=0.012 sec per cm. Thus, the maximum power required by the system depends on the maximum area allowed to the projection system or the maximum beam width of the technology, whichever is smaller. In this example, for a 1 cm window, the surface power required will be 2.70 J/0.012 sec=225 Watts, where the cotton fabric substrate is 170 g/m2=0.017 g/cm², resulting in 225 W*0.012 sec/0.017 g/1340 J/kgK=118.5 Deg Delta-C. Because cotton fiber combusts at approximately 210° C., a pigment compatible with printing on cotton is one that changes color at a temperature low enough to avoid combustion.

If the process technologies or the substrate are not capable of delivering or handling elevated powers, various options of modifying the system and method can include (a) dialing back the speed of the overall system or occasionally pausing the process, thus reducing required peak surface power density, (b) increasing the length of the programming region (e.g., the programming device can be duplicated along the length of the production line, and/or the programming device can be moved further away distributing the pattern over a larger area (but also decreasing the power seen by the substrate with the square of the distance so an increase in source power may need to occur)), and (c) multiple runs can be made through the programming device.

In the context of systems that can render with high precision and deliver a surface power density of 225 watts/cm², laser-based systems could be contemplated, but other systems can be considered if the original visibility and manufacturing requirements are re-evaluated. For example, digital micro-mirror devices can sustain the power density required but finding collimated light sources that can deliver required power over such a short period of time can be difficult. Also, selecting a laser system can be based on a minimum required feature size versus spot size and maximum linear speed across several motion platforms. In this example, the final selection may be the result of numerous iterations over the constraint space of material dynamics, manufacturing requirements, and technological limitations, where the energy of Delta-E relationship of the ink is non-linear and is also likely non-linear with respect to increased power. The programming device can be placed before, during, or after the drying process depending on the constraints of the inks.

In different embodiments, the programmable pigment that is selected for an operation can determine whether the printing should occur in a controlled environment. For example, if a thermochromic ink that changes color at 150 degrees Celsius is selected in an embodiment, such a temperature may not likely be present anywhere else in the production line—except when specifically induced in the programming stage. However, if the temperature at which the thermochromic ink changes color is closer to ambient temperature in a printing environment, then the environment may need to be modified to adjust for this condition, such that the thermochromic ink only changes color at the point at which the color change is desired. Thus, choosing the sensitivity of the inks can be complex decision that considers the surrounding printing steps and conditions.

In different embodiments, the projector can switch off when the ink has been programmed per specification. In other embodiments, the state of the projector can depend on the size of the programmable region with respect to the design as a whole and/or the sensitivity of the other pigments to that particular information carrier. For example, if the programmable region uses photochromics, but the rest of the colored pigments are particularly sensitive to UV, the projector could be turned off whenever possible to limit the amount of leakage to the surrounding areas. Alternatively, the programmable region can also move as the substrate moves underneath it to increase the time the projector has to program the ink and limit exposure to surrounding areas. For example, this can be done by: (a) scrolling an image on the projector at the same linear rate as the substrate, (b) rotating the projector on another axis and using projection mapping to correct for any warp, (c) moving the projector on a linear gantry at the same rate as the substrate using either open or closed loop control, or (d) by duplicating the projectors along the length of the line. Thus, the implementation can be dependent on a number of constraints in the system such as the ratio of the programmable region size to the overall design size along the axis of movement, the space constraints in the production line, etc. Furthermore, in some embodiments, the digital technology used can fine-tune the output as desired. For example, DMD or direct metal deposition uses a duty cycle modulation, such that changing the ratio of on time to off time can be used to effectively create a grayscale effect. In another example, lasers could do either a duty cycle effect in time or space or vary the power output of the laser to reduce the amount of activation.

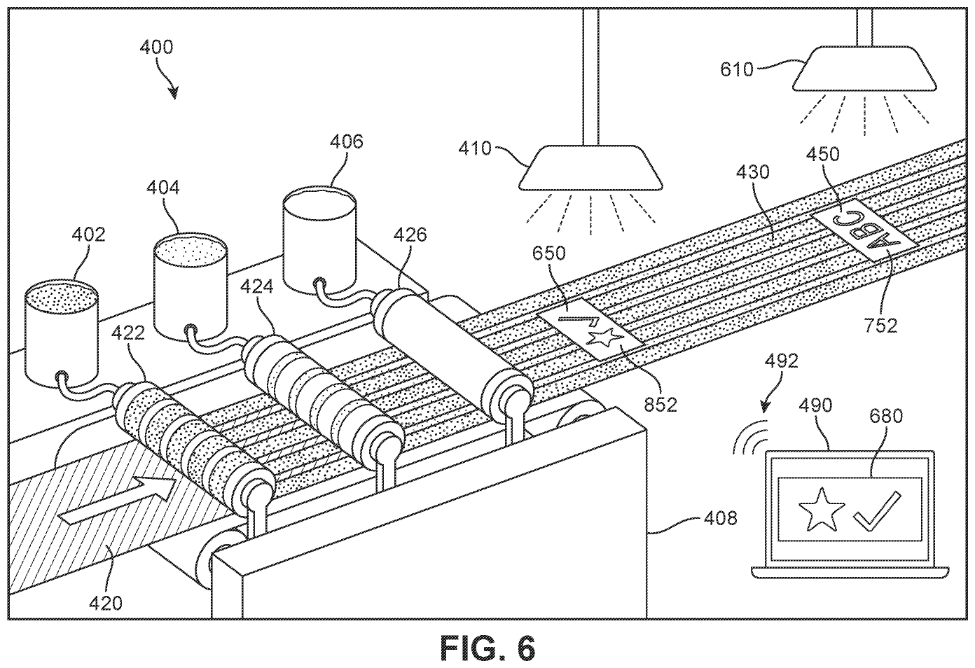

In FIG. 6, the operation continues, with the printed substrate 430 now including a second programmable region 650 applied by the third roller 426. The second programmable region 650 moves until reaching the target area underneath the first projector 410. A similar process as described above with respect to FIG. 5 can occur, though in this case, the design has been modified, such that computing device 490 transmits a second selected design 680 to the first projector 410 over the network 492. When translated into a projected image onto the second programmable region 650, the first projector 410 triggers a color transformation of the blank zone into a second dynamic output 652 (e.g., a star and checkmark icon) corresponding to the second selected design 680. Thus, two different designs are provided with no change in hardware. In this example, the first programmable region 450 also moves forward away from the target projection area. In some embodiments, during the period in which no programmable region is centered beneath the target projection area, the projector can automatically be switched back to the ‘OFF’ state.

In some embodiments, the design utilizes a programmable ink that automatically “locks in” or undergoes a permanent change when exposed to the activation source. For example, in the case of thermochromic inks, an additional lock-in step may not be required because most F & B products are shipped and stored in controlled, low temperature conditions. In some other alternative embodiments, the programmed design can be locked in by applying a layer of UV light blocking paint over this programmable area, to prevent further UV exposure-driven color change in the area. One example is depicted in FIG. 6, where the first programmable region 450 is shown passing under a sprayer 610. The sprayer 610 can apply a protective coating or layer to the printed design as a post-processing step, and ensure the change remains irreversible.

In different embodiments, in order to lock in the color change at the targeted area on the package or label, the mechanism will be selected based on what type of ink was used. For example, if photochromic ink is applied, a UV light can be used to selectively activate parts of the section covered with the color changing photochromic ink. These areas will not undergo any further color change following the exposure to UV light because the color change is irreversible and permanent. However, it is worth noting that areas of the packaging that have the programmable ink and remain unexposed (i.e., do not get activated) might still change color if the UV light is shone on them. Therefore, in order to ‘lock-in’ the pattern across the entire surface of the package, in some embodiments, the entire portion that has been covered with color-changing ink can be also be covered with a layer of UV blocker paint. This application of UV blocker paint will prevent any UV light that shines on the patch/area after the packaging is in its final form from producing an effect. Thus, the desired appearance will remain locked in, and is protected from further color change. This may be particularly useful if the packaging or other substrate is expected to have exposure to UV light from the sun, for example. In the case of thermochromic inks, a UV blocker layer may not be required. This is due to the high temperatures that are typically needed (e.g., greater than 60 Celsius), which the packages are not normally expected to experience. Thus, once the pattern is etched into the package using IR light/lasers and the packaging is ready, it is highly unlikely that the package will see such high temperatures again, as most F & B packages are stored in controlled, dry, and cool conditions for food quality preservation. In some embodiments, the substrate that is used can also affect the type of programming that is selected. For example, the specific heat of the substrate (how much energy is required to raise the temperature of that material a certain amount) can impact the amount of energy required to exact a certain level of color change. In some embodiments, after the application of a protective film or coating and the drying process, the package will be ready for use immediately.

Thus, in different embodiments, the protective process can include polymer laminates such as clear sheets that can be laminated on top after printing has been completed, which can be applied before, during, or after drying stage depending on the requirements of the inks and lamination film. In another example, protection of the programmable region can incorporate liquid clear-coats or varnishes, such as liquid coating that hardens and prevents UV from discoloring the pigments underneath, which can be sprayed or rolled on before, during, or after drying stage. In yet another example, protection can be provided using state-change applications, where a permanent change could be induced after programming to prevent any further change in pigmentation, though this approach would be highly dependent on ink selection. In some embodiments, curing of photochromic or thermochromic ink could be induced chemically (applied similarly to a liquid clear coat) or with an orthogonal mechanism (temperature curing a photochromic to prevent further change).

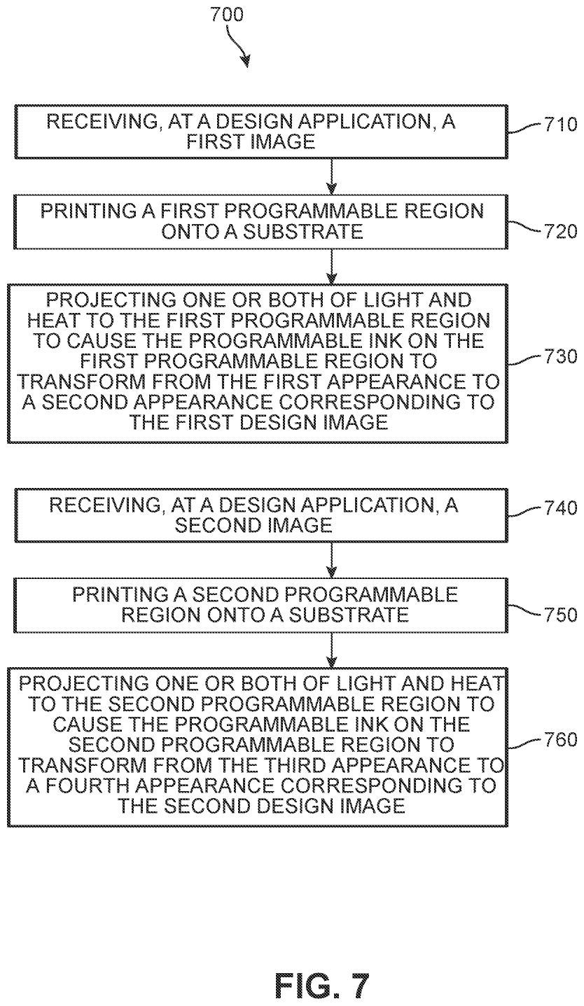

FIG. 7 is a flow chart illustrating an embodiment of a method 700 of managing the printing of designs. The method 700 includes a first operation 710 of receiving, at a design application accessed at a computing device associated with a rotary printing process, a first design image, and a second operation 720 of printing, via a first cylindrical drum of a printing apparatus, a first programmable region onto a substrate, the first programmable region initially including a first appearance. In addition, a third operation 730 includes projecting, via a projector connected to the computing device, one or both of light and heat in a first pattern corresponding to the first image onto the first programmable region, thereby transforming the first appearance to a second appearance based on the first image. A fourth operation 740 includes receiving, at the design application, a second design image, and a fifth operation 750 includes printing programmable ink onto a second programmable region of the substrate, the second programmable region initially including a third appearance. Furthermore, the method includes a sixth operation 760 of projecting one or both of light and heat to the second programmable region to cause the programmable ink on the second programmable region to transform from the third appearance to a fourth appearance corresponding to the second design image.

In other embodiments, the method may include additional steps or aspects. In some embodiments, projecting one or both of light and heat to the first programmable region includes passing the one or both of light and heat through a digital mask. In some embodiments, projecting one or both of the light and heat to the first programmable region includes projecting the one or both of the light and heat in a pattern corresponding to the first design image. In some embodiments, projecting one or both of the light and heat to the first programmable region includes covering the first programmable region with a digital mask having darkened areas corresponding to the inverse of the first design while projecting the one or both of the light and heat to the first programmable region. In some embodiments, the method can also include switching the projector to an on state when the first programmable region is disposed within its target projection area. In one example, the method can further include switching the projector to an off state when a programmable region is outside of the target projection area. In some embodiments, printing programmable ink onto the first programmable region onto the substrate is performed by a first cylindrical drum of a printing apparatus and printing the second programmable region onto the substrate is also performed by the first cylindrical drum.

In another embodiment, the first cylindrical drum of the printing apparatus is supplied with a programmable ink and an appearance of the programmable ink is irreversibly changed when exposed to light and/or heat. In some embodiments, the programmable ink is one of thermochromic ink and photochromic ink. In another example, the projector is one of a laser printing head, digital light processing (DLP) projector, a light-emitting diode (LED) projector, a liquid crystal display (LCD) projector, and a liquid crystal on silicon (LCoS) display. In one embodiment, the method also includes applying a protective coating to the first programmable region after transforming its appearance. In some embodiments, the method further includes switching the projector to an off state when a programmable region is outside of the target projection area.

In different embodiments, a method of managing the printing of designs is also described. This method includes a first operation of receiving, at a design application accessed at a computing device, a first image, and a second operation of printing, via a first cylindrical drum of a printing apparatus, a first programmable region onto a substrate, the first programmable region initially including a first appearance. In addition, a third operation includes projecting, via a projector connected to the computing device, one or both of light and heat in a first pattern corresponding to the first image onto the first programmable region, thereby transforming the first appearance to a second appearance based on the first image. In other embodiments, the method may include additional steps or aspects. In some embodiments, the method can also include switching the projector to an on state when the first programmable region is disposed within its target projection area. In another embodiment, the first cylindrical drum of the printing apparatus is supplied with a programmable ink and an appearance of the programmable ink is irreversibly changed when exposed to light and/or heat. In some embodiments, the programmable ink is one of thermochromic ink and photochromic ink. In different embodiments, the method also includes steps of receiving, at the design application, a second image; printing, via the first cylindrical drum, a second programmable region onto the substrate, the second programmable region initially including a third appearance; and projecting, via the projector, one or both of light and heat in a second pattern corresponding to the second image onto the second programmable region, thereby transforming the third appearance to a fourth appearance based on the second image.

In some embodiments, the systems described herein can include an ink reservoir; a first cylindrical drum of a printing apparatus in fluid communication with the ink reservoir; a conveyor for conveying a substrate adjacent to the paint roller; a projector positioned adjacent to the conveyor such that the projector can project one or both of heat and light onto the substrate; a device processor in electrical communication with at least the projector; and a non-transitory computer-readable medium (CRM) storing software comprising instructions executable by the device processor which, upon such execution, cause the device processor to perform one or more of the following operations: receive, at the device processor, a first design image; automatically control the first cylindrical drum to print programmable ink onto a first programmable region of a first substrate, the first programmable region initially including a first appearance; automatically control the projector to project one or both of light and heat to the first programmable region to cause the programmable ink on the first programmable region to transform from the first appearance to a second appearance corresponding to the first design image; receive, at the device processor, a second design image; automatically control the first cylindrical drum to print programmable ink onto a second programmable region of a second substrate, the second programmable region initially including a third appearance; and automatically control the projector to project one or both of light and heat to the second programmable region to cause the programmable ink on the second programmable region to transform from the third appearance to a fourth appearance corresponding to the second design image.

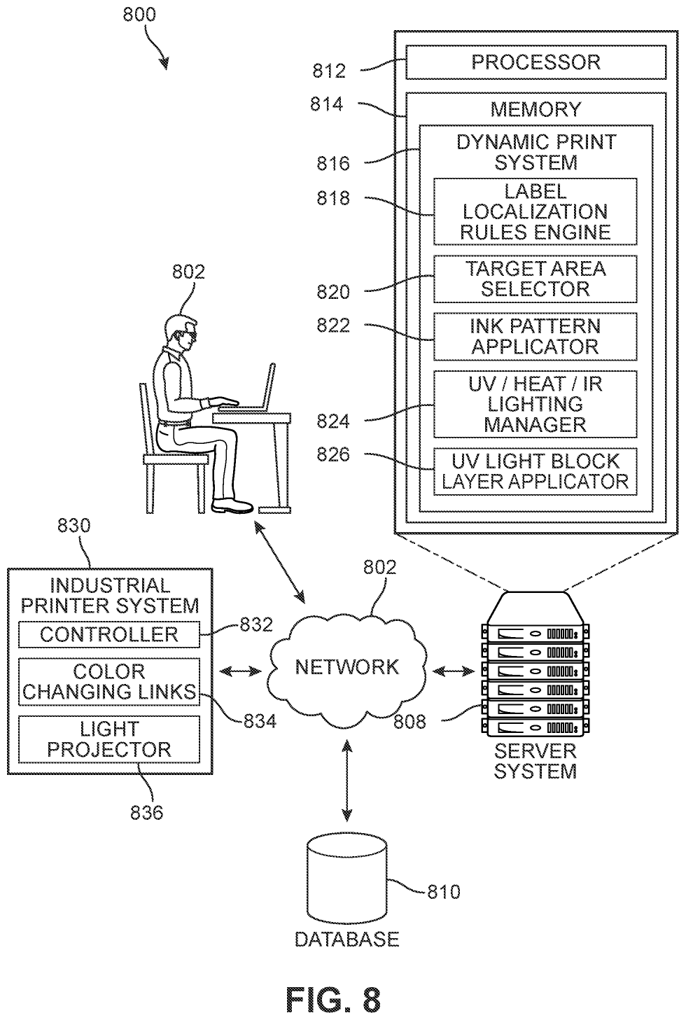

For purposes of reference, FIG. 8 presents a schematic diagram of a dynamic printing environment 800 (or environment 800), according to an embodiment. The environment 800 may include a plurality of components capable of performing the disclosed method of dynamic label printing. For example, environment 800 includes a first user device 804, computing system 808, a network 802, and a database 810. The components of environment 800 can communicate with each other through network 802. In some embodiments, network 802 may be a wide area network (“WAN”), e.g., the Internet. In other embodiments, network 802 may be a local area network (“LAN”).

As shown in FIG. 8, a dynamic print system 816 may be hosted in computing system 808, which may have a memory 814 and a processor 812. Processor 812 may include a single device processor located on a single device, or it may include multiple device processors located on one or more physical devices. Memory 814 may include any type of storage, which may be physically located on one physical device, or on multiple physical devices. In some cases, computing system 808 may comprise one or more servers that are used to host the dynamic print system 816 and its associated modules (label localization rules engine 818, target area selector 820, ink pattern applicator 822, UV/heat/IR lighting manager, and UV light block layer applicator).

In different embodiments, database 810 may store data that may be retrieved by other components for environment 800, such as government requirements for labels or country-specific requirements for labels, as well as a design pattern options repository. In different embodiments, the database 810 can include a manufacturer's pattern records that may include, for example, color codes that are linked to each type of label section and country or localization rule. In some embodiments, the database 810 includes a knowledge repository that can be used by label localization rules engine 818 to determine which patterns should be applied during a given print session, and which ink color(s) should be exposed to the trigger mechanism. In addition, a target area selector 820 can be used to identify the portion of the label that should be printed using the color-changing ink(s), and an ink pattern applicator 822 can determine what layers of color and type of designs should be printed on the designated portion, which can communicate over network 802 with a controller module 832 of an industrial printer system 830 to guide the printing output of color changing inks 834.

In some embodiments, the UV/heat/IR lighting manager 824 can also communicate with the controller module 832 to cause a light projector 836 of the industrial printer system 830 to activate when appropriate in order to lock-in the desired color pattern. Similarly, UV light block layer applicator 826 can instruct the controller module 832 to initiate the application of UV light block to one or more portions of the product to ensure subsequent color changes are prevented.

While FIG. 8 shows a single user device, it is understood that more user devices may be used. For example, in some embodiments, the system may include two or three user devices. The user may include an individual seeking guidance on how to perform a particular task or understand a specific concept. In some embodiments, the user device may be a computing device used by a user. For example, first user device 804 may include a smartphone or a tablet computer. In other examples, first user device 804 may include a laptop computer, a desktop computer, and/or another type of computing device. The user devices may be used for inputting, processing, and displaying information.

The number and arrangement of components shown in FIG. 8 are provided as an example. In practice, the system may include additional components, fewer components, different components, or differently arranged components than those shown in FIG. 8. Additionally, or alternatively, a set of components (e.g., one or more components) of the system may perform one or more functions described as being performed by another set of components of the environment 800.

One of the more potent advantages of the proposed system is its ability to readily integrate with techniques already utilized by industries (e.g., rotary printing processes). In different embodiments, the sections of the packaging that need to be printed with the color changing inks will be printed at the very end of the process, involving only the last one or few rollers in the operation. A UV light source, laser light source, and/or IR light source projector can be easily mounted above the equipment toward the end of the production line in anticipation of the programmed exposure that is to occur. The system will then precisely activate the color-changing inks in a predefined pattern such that the text becomes visible and/or appears as a different color as compared to its background. Finally, in some embodiments, a roller or other application mechanism can coat the areas that were coated with the color-changing inks with a UV blocker paint, to prevent further UV exposure (e.g., during shipping/transit/storage). By applying irreversible color changing inks to regions of the design that are expected to change over time (“dynamic information”)—such as regulatory information, nutrition labels, ingredient lists, or dates—the region can be dynamically updated by a relatively simple modification to the electronic design.

In other words, existing rotary printing processes can incorporate the proposed system without difficulty while maintaining their speed of production. The described components can be integrated readily within the existing infrastructure present in these lines—for example, the projector can be inserted into the existing drying system, or multiple projectors can be installed in positions along the line if more exposure time is desired. The designs themselves can be adapted and scaled to the substrate's three-dimensional shape, whether in narrow strips, large swatches of areas, or small print regions.

Thus, the proposed process requires minimal and relatively inexpensive modifications to the existing process, essentially comprising color changing inks, pre-programmed designs, a light projector, and an extra set of rollers incorporated at the end of the printing line. It can be appreciated that this type of transformational technology approach allows for a unique flexibility in design while nevertheless maintaining the same benefits that roller (rotary) printing has provided over digital printing in terms of cost, throughput, and color quality.

The examples described herein show only some of many possible different implementation contexts. In that respect, the technical solutions are not limited in their application to the architectures and systems shown in the drawings, but are applicable to many other implementations, architectures, and processing.

It should be understood that the text, images, and specific application features shown in the figures are for purposes of illustration only and in no way limit the manner by which the application may communicate or receive information. In addition, in other embodiments, one or more options or other fields and text may appear differently and/or may be displayed or generated anywhere else on the screen(s) associated with the client's system, including spaced apart from, adjacent to, or around the user interface. In other words, the figures present only one possible layout of the interface, and do not in any way limit the presentation arrangement of any of the disclosed features.

Embodiments may include a non-transitory computer-readable medium (CRM) storing software comprising instructions executable by one or more computers or device processors which, upon such execution, cause the one or more computers or device processors to perform aspects of the disclosed methods. Non-transitory CRM may refer to a CRM that stores data for short periods or in the presence of power such as a memory device or Random Access Memory (RAM). For example, a non-transitory computer-readable medium may include storage components, such as, a hard disk (e.g., a magnetic disk, an optical disk, a magneto-optic disk, and/or a solid state disk), a compact disc (CD), a digital versatile disc (DVD), a floppy disk, a cartridge, and/or a magnetic tape.

To provide further context, in some embodiments, some of the processes described herein can be understood to operate in a system architecture that can include a plurality of virtual local area network (VLAN) workstations at different locations that communicate with a main data center with dedicated virtual servers such as a web server for user interfaces, an app server for data processing, a database for data storage, etc. As a general matter, a virtual server is a type of virtual machine (VM) that is executed on a hardware component (e.g., server). In some examples, multiple VMs can be deployed on one or more servers.

In addition, the dynamic print system can include one or more devices capable of receiving, generating, storing, processing, and/or providing information, such as information described herein. For example, dynamic print system may include one or more computing devices, such as one or more server devices, desktop computers, workstation computers, virtual machines (VMs) provided in a cloud computing environment, or similar devices. The systems can exchange information over one or more wired and/or wireless networks. For example, networks may include a cellular network, a public land mobile network (PLMN), a local area network (LAN), a personal area network (PAN) such as Bluetooth, a wide area network (WAN), a metropolitan area network (MAN), a telephone network (e.g., the Public Switched Telephone Network (PSTN)), an ad hoc network, an intranet, the Internet, a fiber optic-based network, a cloud computing network, a private network, and/or a combination of these or other types of networks.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

While various embodiments are described, the description is intended to be exemplary, rather than limiting and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted.

This disclosure includes and contemplates combinations with features and elements known to the average artisan in the art. The embodiments, features and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

While various embodiments of the invention have been described, the description is intended to be exemplary, rather than limiting, and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

We claim:

1. A method of printing designs, the method comprising:
receiving, at a design application accessed at a computing device associated with a rotary printing process, a first design image;
printing programmable ink onto a first programmable region of a substrate, the first programmable region initially including a first appearance;
projecting one or both of light and heat to the first programmable region to cause the programmable ink on the first programmable region to transform from the first appearance to a second appearance corresponding to the first design image;
receiving, at the design application, a second design image;
printing programmable ink onto a second programmable region of the substrate, the second programmable region initially including a third appearance; and
projecting one or both of light and heat to the second programmable region to cause the programmable ink on the second programmable region to transform from the third appearance to a fourth appearance corresponding to the second design image.

2. The method of claim 1, wherein projecting one or both of light and heat to the first programmable region includes passing the one or both of light and heat through a digital mask.

3. The method of claim 1, wherein projecting one or both of the light and heat to the first programmable region includes projecting the one or both of the light and heat in a pattern corresponding to the first design image.

4. The method of claim 1, wherein projecting one or both of the light and heat to the first programmable region includes covering the first programmable region with a digital mask having darkened areas corresponding to an inverse of the first design while projecting the one or both of the light and heat to the first programmable region.

5. The method of claim 1, further comprising switching a projector to an on state when the first programmable region is disposed within its target projection area.

6. The method of claim 5, further comprising switching the projector to an off state when a programmable region is outside of the target projection area.

7. The method of claim 1, wherein printing programmable ink onto the first programmable region onto the substrate is performed by a first cylindrical drum of a printing apparatus and wherein printing the second programmable region onto the substrate is also performed by the first cylindrical drum.

8. The method of claim 1, wherein the programmable ink is one of thermochromic ink and photochromic ink.

9. The method of claim 1, wherein projecting one or both of light and heat includes projecting light by a projector including one of a laser printing head, thermal resistive printing head, a digital light processing (DLP) projector, a light-emitting diode (LED) projector, a liquid crystal display (LCD) projector, and a liquid crystal on silicon (LCoS) display.

10. The method of claim 1, further comprising applying a protective coating to the first programmable region after transforming its appearance.

11. A method of printing designs, the method comprising:
receiving, at a design application accessed at a computing device associated with a rotary printing process, a first design image;
printing programmable ink onto a first programmable region of a first substrate, the first programmable region initially including a first appearance;
projecting one or both of light and heat to the first programmable region to cause the programmable ink on the first programmable region to transform from the first appearance to a second appearance corresponding to the first design image;
receiving, at the design application, a second design image;
printing programmable ink onto a second programmable region of a second substrate, the second programmable region initially including a third appearance; and
projecting one or both of light and heat to the second programmable region to cause the programmable ink on the second programmable region to transform from the third appearance to a fourth appearance corresponding to the second design image.

12. The method of claim 11, wherein projecting one or both of light and heat to the first programmable region includes passing the one or both of light and heat through a digital mask.

13. The method of claim 11, wherein projecting one or both of the light and heat to the first programmable region includes projecting the one or both of the light and heat in a pattern corresponding to the first design image.

14. The method of claim 11, wherein projecting one or both of the light and heat to the first programmable region includes covering the first programmable region with a digital mask having darkened areas corresponding to an inverse of the first design while projecting the one or both of the light and heat to the first programmable region.

15. The method of claim 11, further comprising switching a projector to an on state when the first programmable region is disposed within its target projection area.

16. The method of claim 15, further comprising switching the projector to an off state when a programmable region is outside of the target projection area.

17. The method of claim 11, wherein printing programmable ink onto the first programmable region onto the first substrate is performed by a first cylindrical drum of a printing apparatus and wherein printing the second programmable region onto the second substrate is also performed by the first cylindrical drum.

18. The method of claim 11, wherein the programmable ink is one of thermochromic ink and photochromic ink.

19. The method of claim 11, wherein projecting one or both of light and heat includes projecting light by a projector including one of a laser printing head, thermal resistive printing head, a digital light processing (DLP) projector, a light-emitting diode (LED) projector, a liquid crystal display (LCD) projector, and a liquid crystal on silicon (LCoS) display.

20. A system for printing designs, comprising:
an ink reservoir;
a first cylindrical drum of a printing apparatus in fluid communication with the ink reservoir;
a conveyor for conveying a substrate adjacent to the paint roller;
a projector positioned adjacent to the conveyor such that the projector can project one or both of heat and light onto the substrate;
a device processor in electrical communication with at least the projector;
a non-transitory computer-readable medium (CRM) storing software comprising instructions executable by the device processor which, upon such execution, cause the device processor to:
receive, at the device processor, a first design image;
automatically control the first cylindrical drum to print programmable ink onto a first programmable region of a first substrate, the first programmable region initially including a first appearance;
automatically control the projector to project one or both of light and heat to the first programmable region to cause the programmable ink on the first programmable region to transform from the first appearance to a second appearance corresponding to the first design image;
receive, at the device processor, a second design image;
automatically control the first cylindrical drum to print programmable ink onto a second programmable region of a second substrate, the second programmable region initially including a third appearance; and
automatically control the projector to project one or both of light and heat to the second programmable region to cause the programmable ink on the second programmable region to transform from the third appearance to a fourth appearance corresponding to the second design image.
